(19) United States
(12) Patent Application Publication
(10) Pub. No.: US 2011/0135966 A1
(43) Pub. Date: Jun. 9, 2011

(54) NOVEL COW-DUNG BASED MICROBIAL FUEL CELL

(76) Inventor: Vishnu Jayaprakash, Chennai (IN)

(21) Appl. No.: 12/631,812

(22) Filed: Dec. 5, 2009

(30) Foreign Application Priority Data
Dec. 5, 2009 (IB) PCT/IB2009/055530

(51) Int. Cl. H01M 8/16; H01M 8/00

(52) U.S. Cl. 429/2; 429/535

(57) ABSTRACT

A novel cow dung based Microbial Fuel Cell (MFC) comprising of graphite electrodes and a proton exchange membrane and that converts chemical energy available in a bio-convertible substrate directly into electricity and achieves this by using the microorganisms in cow dung as a catalyst to convert substrate into electrons.

### FIELD OF INVENTION

The present invention belongs to the field of electrolytic process devices and relates to an electrochemical current generator. More particularly the invention relates to a cow dung based microbial fuel cell containing indigenous/alternate electrodes and a proton exchange membrane, and used for generating electrochemical current, especially for lighting in rural areas.

### BACKGROUND OF INVENTION

A Microbial Fuel cell (MFC) is a bioreactor which converts chemical energy in the organic compounds in to electrical energy by catalytic reactions of microorganisms under anaerobic conditions. The microorganisms interact with electrodes using electrons, which are either removed or supplied through an electrical circuit. Thus microbial fuel cells can convert biomass spontaneously into electricity through the metabolic activity of the microorganisms.

A typical microbial fuel cell consists of anode and cathode compartments separated by a cation specific membrane. In the anode compartment, fuel is oxidized by microorganisms, generating electrons and protons. Electrons are transferred to the cathode compartment through an external electric circuit, and the protons are transferred to the cathode compartment through the membrane. Electrons and protons are consumed in the cathode compartment, combining with oxygen to form water. In general, there are two types of microbial fuel cells, mediator and mediator-less microbial fuel cells.

A mediator-less microbial fuel cell does not require a mediator but uses electrochemically active bacteria to transfer electrons to the electrode (electrons are carried directly from the bacterial respiratory enzyme to the electrode).

Microbial fuel cells have a number of potential uses. The first and most obvious is harvesting the electricity produced for a power source. The idea of using microbial cells in an attempt to produce electricity was first conceived at the turn of the nineteenth century. Microbial fuel cells can be actively harnessed to provide energy to even remote areas which do not posses modern day amenities. This is particularly relevant in developing countries that have focused on energy management and on discovering alternate energy source to combat diminishing natural energy resources.

There are several available microbial fuel cells that envisage the use of various organic materials to derive energy, a popular example being wastewater. However there is a need for a microbial fuel cell that is easily constructible using cheap every day indigenously available raw material and that is highly efficient and long lived.

The relevant prior art devices concerning the use and manufacture of microbial fuel cells or biofuel cells, are as follows:

U.S. Pat. No. 5,660,940 discloses a method for producing electric energy in a biofuel-powered fuel cell, the metal in the first acid metallic salt solution forming a redox pair having a normal potential between −0.1 and 0.7 V and the metal in the second acid metallic salt solution forming a redox pair having a normal potential between 0.7 and 1.3 V, both metals preferably being vanadium which forms the redox pairs vanadium(IV)/(III) and vanadium (V)/(IV), respectively; carbohydrate being supplied as fuel to the first reactor (1) and the reaction in the first reactor (1) being effected in the presence of platinum or ruthenium as the first catalyst (2).

U.S. Pat. No. 7,572,546 claims a new type of biofuel cell, based on the microbial regeneration of the oxidant, ferric ions. The bio-fuel cell is based on the cathodic reduction of ferric to ferrous ions, coupled with the microbial regeneration of ferric ions by the oxidation of ferrous ions, with fuel (such as hydrogen) oxidation on the anode. The microbial regeneration of ferric ions is achieved by chemolithotrophic microorganisms such as Acidithiobacillus ferroxidans. Electrical generation is coupled with the consumption of carbon dioxide from atmosphere and its transformation into microbial cells, which can be used as a single-cell protein.

U.S. Pat. No. 5,976,719 describes a biofuel cell which can react with an electrode without mediator. The microorganism of a biofuel cell according to the present invention can directly consume the electrons generated from a fermentative metabolism of the microorganism through an electron metabolism without energy conservation. Therefore, if waste water is utilized as a fuel (substrate) in the biofuel cell according to the present invention, the amount of sludge production will be reduced and the efficiency of catabolizing organic materials will be increased

U.S. Pat. No. 4,652,501 describes that in operation of a microbial fuel cell it has been found that improved efficiency results if the microbes are kept ‘hungry’, i.e. the cell is run under conditions of fuel supply and load such that electrical output is dependent on fuel concentration, rather than as is conventionally the case being run under excess fuel so that power output is concentration independent. A method and apparatus are described to enable fuel cells to be run under energetic or coulombic efficiency control.

U.S. Patent Publication No: 20090087690 discloses a microbial fuel cell with anion exchange membrane and solid oxide catalyst wherein a platinum catalyst has been used in conjunction with a graphite cathode to enhance the energy density of the electro-reduction process at the cathode, thereby resulting in a fuel cell having increased power.

U.S. Patent Publication No: 20070059565 claims a microbial fuel cell that includes a bio-compatible body having a micro-pillar structure defining an anode compartment adapted to contain a catalyst that metabolizes glucose to generate electrons and protons. A nano-porous membrane prevents loss of the catalyst from the anode compartment, while providing fluid access for ingress of glucose fuel and egress of waste.

U.S. Patent Publication No: 20080160384 discloses a method of forming, producing or manufacturing functionalized and soluble nanomaterials, most specifically carbon nanotubes on a substrate, which can be used in the production or manufacture of biofuel cells.

U.S. Patent Publication No: 20090047567 mentions a biofuel cell that has a structure in which a cathode and an anode are opposed to each other with a electrolyte layer provided therebetween, at least one of the cathode and the anode including an electrode on which at least one enzyme and at least one electron mediator are immobilized. The concentration of the electron mediator immobilized on the electrode is at least 10 times a Michaelis constant K.sub.m of the electron mediator for the enzyme, which is determined by measurement in a solution.

U.S. Patent Publication No: 20050255345 claims a method and device for processing organic waste in an environmentally friendly manner. The waste flow is processed in a bipolar biofuel cell. The waste is introduced into a space having a pair of electrodes, which includes at least one anode and at least one cathode, while in a bipolar cell the anode and cathode are separated spatially and/or by a porous, electronically non-conductive, non-ion-selective wall, while an oxidizer is introduced in the space around the cathode, and where a potential difference is formed across the pair of electrodes such that at the anode CO.sub.2 is produced and electricity is produced.

However the purpose and methodology of all the inventions that are part of prior art do not envisage the unique embodiment of a microbial fuel cell that is easily constructible using cheap every day indigenously available raw material and that is highly efficient and long lived.

There thus exists a need for a microbial fuel cell that is easily readily available for every day use in the remotest of villages. The present invention has been accomplished to eliminate these limitations.

Further it will be apparent to those skilled in the art that the objects of this invention have been achieved by providing a cowdung based microbial fuel cell that is capable of overcoming the aforesaid disadvantages which is unique in nature unlike existing microbial fuel cells that are suited only for limited purposes. Various changes may be made in and without departing from the concept of this invention. Further, features of some stages disclosed in this application may be employed with features of other stages. Therefore, the scope of the invention is to be determined by the terminology of the following description and the legal equivalents thereof.

### SUMMARY OF THE INVENTION

This present invention may be summarized, at least in part, with reference to its objects.

Accordingly, it is an objective of the present invention to provide a novel microbial fuel cell that provides cheap and cost effective electrical energy source for applications in Indian villages.

Another objective of the present invention is to provide a novel microbial fuel cell that contains raw materials which are easy to source and indigenous to the villages.

Another objective of the present invention is to provide a novel microbial fuel cell that contains raw materials which are inexpensive

Another objective of the present invention is to provide a novel microbial fuel cell that is highly efficient.

A further objective of the present invention is to provide a novel microbial fuel cell that can be used to power small DC components and electrical appliances in remote areas.

Yet another objective of the present invention is to provide a novel microbial fuel cell that can operate over wide temperature gradients and can be used in outer spaces and deep sea probes.

Yet another objective of the present invention is to provide a novel microbial fuel cell that has long life compared to existing microbial fuel cells.

The present invention provides a Microbial Fuel Cell (MFC) converts chemical energy available in a bio-convertible substrate directly into electricity and achieves this by using the microorganisms in cow dung as a catalyst to convert substrate into electrons. The microbial fuel cell in the present invention consists of two anaerobic compartments separated by a proton/ion exchange membrane (PEM/IEM). One compartment contains the anode (negative electrode), while the other contains the cathode (positive electrode). Cow dung slurry is used as the catalyst and anionic solution and Poly Vinyl Alcohol Sulfosuccinic Acid (PVASSA) is used as a proton exchange membrane. Indigenous graphite sheets are designed for use as the electrodes in the present invention. The cathode chamber is filled with potassium ferricyanide.

Additional objects and embodiments of the invention will be set forth in part in the description which follows, and in part will become apparent to those skilled in the art upon examination of the following, or may be learned by practice of the invention. These and other objects and advantages and features of the present invention will be more readily apparent when considered in reference to the following description, and in part will become apparent to those skilled in the art upon examination of the following, or may be learned by practice of the invention.

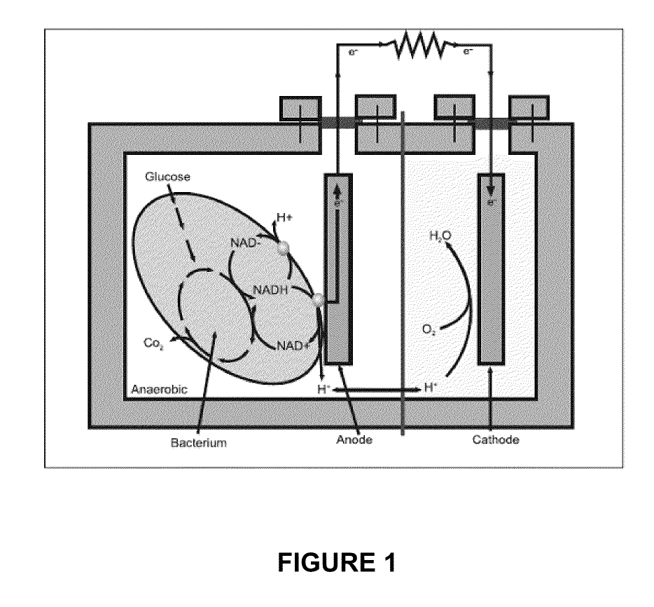

FIG. 1 is a cross sectional schematic representation of the present invention which is used as reference for the following description and claims.

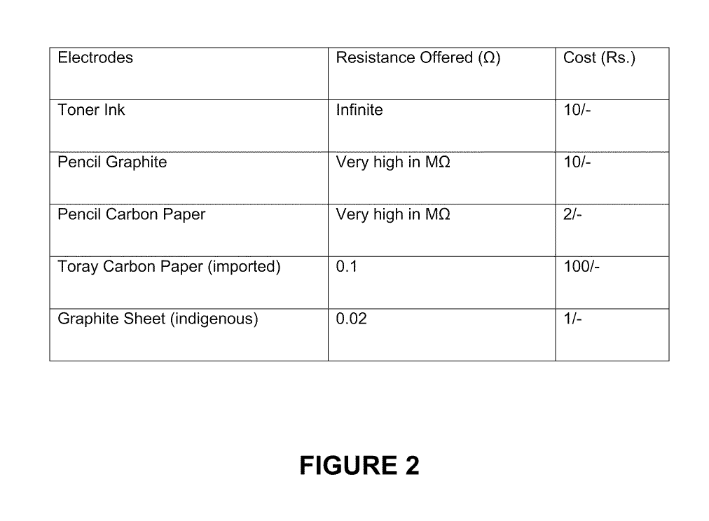

FIG. 2 is a tabulated representation of various electrodes tested for use in the present invention.

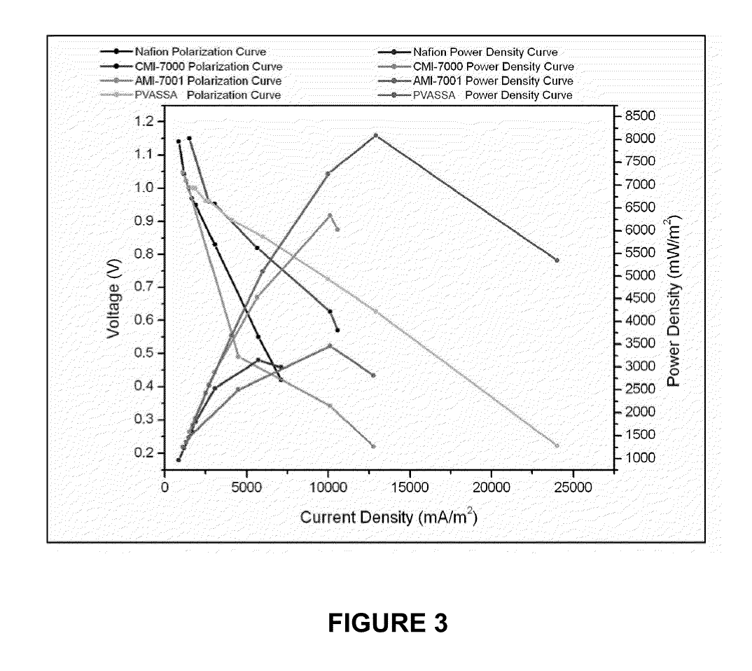

FIG. 3 is a graph of showing Power Density and polarization curves for microbial fuel cells using different membranes in the present invention.

### DETAILED DESCRIPTION OF THE INVENTION

The following description is presented to enable any person skilled in the art to make and use the invention, and is provided in the context of particular applications of the invention and their requirements. The present invention can be configured as follows:

The present invention provides a Microbial Fuel Cell (MFC) converts chemical energy available in a bio-convertible substrate directly into electricity. To achieve this, microorganisms in cow dung are used as a catalyst to convert substrate into electrons. Thus the present invention envisages the generation of electrochemical current using a cow dung based microbial fuel cell containing indigenous/alternate electrodes and a proton exchange membrane.

The microbial fuel cell in the present invention consists of two anaerobic compartments separated by a proton/ion exchange membrane (PEM/IEM). One compartment contains the anode (negative electrode), while the other contains the cathode (positive electrode). The catalyst used over here is microorganisms.

In the first preferred embodiment, any animal excreta including cowdung rich in microbial population for use as the catalyst, is obtained fresh from the same place, sun dried at regular intervals, and mixed and crushed in order to ensure even drying and mixing of nutrients. The drying process through exposure to sun rays is completed in 2-4 weeks. The cow dung slurry is prepared specifically by mixing dry cow dung, fresh cow dung and water to be made up to 36 ml to get optimum results. The main advantage of using cow dung slurry is that it is a self-buffered substrate with rich microbial consortium.

In the second preferred embodiment, the chamber of the present microbial fuel cell invention is constructed with acrylic material using the requisite number of nuts, bolts and washers. The chamber is compartmentalized into the anode and cathode compartments using acrylic sheets.

In the third preferred embodiment, said compartments house a specific portion of proton exchange membrane (PEM) between them. Various PEMs for use such as Nafion membrane, CMI-7000, AMI-7001, and Poly Vinyl Alcohol Sulfa Succinic Acid (PVASSA) were considered. Poly Vinyl Alcohol Sulfa Succinic Acid (PVASSA) and CMI-7000 were identified for use due to being inexpensive, and due its providing higher power and current densities. However the proton exchange membrane may be also made of Sulphonated Poly ether-ether-ketone (sPEEK) or CMI-7000 or AMI-7000 having pores extending throughout and is placed securely without leakage of materials by means of two neoprene gaskets in between the anode and cathode chambers.

In the fourth preferred embodiment, said PEM is held in place using two neoprene gaskets. Said neoprene gaskets help to avoid the leakage of material from the compartments.

In the fifth preferred embodiment, various electrodes for use such as toner ink, pencil graphite, pencil carbon paper, imported toray carbon paper and indigenous graphite sheet were considered as depicted in FIG. 2. Indigenously made graphite sheet was identified for use due to being 99% cheaper than carbon paper, and due to its offering 5 times (20%) less resistance than the imported carbon paper. This results in a 50% cost reduction when compared to average microbial fuel cells. A 5 cm×5 cm graphite sheet electrode is designed for use as the electrodes in the present invention. Small holes were bored into said graphite sheets. Copper wires were inserted into said holes and tightened onto said graphite sheet using nut and bolt and fixed with Araldite.

In the sixth preferred embodiment, the anode chamber is filled with anodic solution made of said cowdung slurry substrate and the cathode chamber is filled with 100 mM of potassium ferricyanide (K₃Fe(CN)₆).

In normal microbial catabolism (ETC), a substrate such as carbohydrate is oxidized initially without participation of oxygen, while its electrons are taken up by an enzyme-active site the reaction being

C6H12O6+6H2O=6CO2+24e−+24H+

In the process involved in the working of the present invention, the microorganisms present in the cow dung substrate in the anode chamber catalyze the decomposition of glucose present in the substrate releasing electrons.

In the absence of oxygen, the electrons are diverted to the electrode and captured by the anode by some means (extracellular proteins or electron mediators), made to pass through the outer circuit, and ultimately combine with an electron sink. This electron sink is usually ferricyanide or oxygen which accepts the incoming electrons from the cathode and gets reduced.

4Fe(CN)₆³⁻+4e−=4Fe(CN)₆⁴⁻

Simultaneously protons formed by oxidation traverse across the proton exchange membrane into the cathode compartment where they are reduced to produce electrons. Ferrocyanide is re-oxidized to ferricyanide, while the hydrogen ions combine with oxygen to form water.

4Fe(CN)₆⁴⁻+4H⁺+O₂=4Fe(CN)₆³⁻−+2H₂O

Thus an electrical power is obtained by making the electrical connection between a load and the anode and the cathode.

In order to monitor the bacterial presence on the graphite sheet during use in the present invention, Scanning Electron Microscopy (SEM) pictures were taken and active catalyst activity was detected.

Voltage and current are measured using a commercial Digital Multimeter. Current is drawn from the present invention using the various loads connected to the present invention using connecting wires. The Voltage and Current values for the corresponding load are then noted. Power Density values and Polarization values are calculated and plotted by submitting the values of the obtained voltage and current values in the under mentioned formulas.

The power delivered by an electrical system is mathematically defined as:

P=V×1

Where,

P=Power (in watts)

V=Voltage (in volts)

I=Current (in amperes)

The Power Density (PD) defined as the power delivered per unit area of an electrode surface is:

$$PD = \frac{P}{Total Surface Area of the Anode}$$

Similarly, the Current Density (CD) is expressed as:

$$CD = \frac{I}{Total Surface Area of the Anode}$$

Low internal resistance offered by the said microbial fuel cell due to the ideal electrode and small distance between the two electrodes (10 mm).

FIG. 3 depicts a graph that shows the Power Density and polarization curves for microbial fuel cells using different membranes

In terms of efficiency, the highest power-density values recorded for other microbial fuel cells are about 6 W/m² whereas the present invention produces about 8 W/m² while using PVASSA.

The present invention can be used for small DC components such as LED, watch, calculator etc. However the main application is for lighting in rural India using ultra bright LEDs.

While there has been shown and described what is considered to be preferred embodiments of the invention, it will, of course, be understood that various modifications and changes in form or detail could readily be made without departing from the spirit of the invention. It is therefore intended that the invention be not limited to the exact forms described and illustrated, but should be constructed to cover all modifications that may fall within the scope of the appended claims.

It will be apparent to those skilled in the art that the objects of this invention have been achieved by providing the above invention. However various changes may be made in the structure of the invention without departing from the concept of the invention. Therefore, the scope of the invention is to be determined by the terminology of the following claims and the legal equivalents thereof.

What is claimed is:

1. A microbial fuel cell, comprising an anode and cathode compartments made of acrylic sheets, anode and cathode made of graphite sheets, having an anode surface area and a cathode surface area, characterized in that a Poly Vinyl Alcohol Sulfosuccinic Acid proton exchange membrane disposed between the anode and the cathode, and a substrate of cowdung disposed on the anode compartment and plurality of microbes present in the cowdung catalyse the reaction at the anode by decomposing the glucose present in the cowdung releasing electrons and protons, wherein the protons cross Poly Vinyl Alcohol Sulfosuccinic Acid membrane into the cathode and the electrons absorbed by the anode pass through an external circuit reaching the cathode, thereby completing an electrical connection between a load and the graphite sheet electrodes resulting in power generation.

2. A method of fabricating a microbial fuel cell having an anode and cathode compartments characterized in that anode and cathode compartments made of acrylic sheets, the anode and cathode electrodes made of graphite sheets, a proton exchange membrane made of Poly Vinyl Alcohol Sulfosuccinic Acid disposed between the anode and the cathode, and a substrate of cowdung disposed on the anode compartment and potassium ferricyanide filled in the cathode compartment and an electrical connection between a load and the electrodes.

3. The microbial fuel cell as claimed in claim 1 and claim 2 wherein the membrane permeable to any cations including protons is made of Poly Vinyl Alcohol Sulfosuccinic Acid having pores extending throughout.

4. The microbial fuel cell as claimed in claim 1 wherein the Poly Vinyl Alcohol Sulfosuccinic Acid membrane is placed securely without leakage of materials by means of two neoprene gaskets in between the anode and cathode chambers.

5. The microbial fuel cell as claimed in claim 1 wherein the membrane permeable to any cations including protons can be made of Sulphonated Poly ether-ether-ketone (sPEEK) or CMI-7000 or AMI-7000 having pores extending throughout and is placed securely without leakage of materials by means of two neoprene gaskets in between the anode and cathode chambers.

6. The microbial fuel cell as claimed in claim 1 and claim 2 wherein the graphite sheets are made into electrodes by boring a small hole into the sheet and tightening it to the copper wire using nut and bolt resulting in increased current density and power density.

7. The microbial fuel cell as claimed in claim 1, claim 2 and claim 6 wherein the electrodes are made of indigenously available graphite sheet with 20% less resistance than the imported carbon paper and 90% cheaper than imported carbon paper.

8. The microbial fuel cell as claimed in claim 1 and claim 2 wherein the substrate used is any animal excreta including cowdung rich in microbial population.

9. The microbial fuel cell as claimed in claim 1, claim 2 and claim 8 wherein the cowdung slurry is prepared by mixing required amount of cowdung with water and pre-digested slurry in the ratio of 1:10.

10. The microbial fuel cell as claimed in claim 1, claim 2, claim 8 and claim 9 wherein the cowdung is left open for sun drying during the day time for a period of 2 to 4 weeks and at regular intervals the cowdung was mixed and crushed in order to ensure even drying and mixing of nutrients.

11. The microbial fuel cell as claimed in claim 1 wherein efficiency in terms of the power-density values is above 8 W/m2.

12. The microbial fuel cell as claimed in claim 1 and claim 2 wherein due to its affordability and ease in maintenance can be used for lighting in rural and remote areas.

13. The microbial fuel cell as claimed in claim 1 and claim 2 wherein due to its small and compact design can be used to power small electrical appliances including but not restricted to watches, calculators, etc.

14. The microbial fuel cell as claimed in claim 1 and claim 2 wherein the fuel cell can operate at wide temperature gradient,

15. The microbial fuel cell as claimed in claim 1, claim 2 and claim 14 wherein due to its operation at wide temperature gradient can be used in outer spaces and deep sea probes.
